(19) United States
(12) Patent Application Publication
(10) Pub. No.: US 2020/0214504 A1
(43) Pub. Date: Jul. 9, 2020

(54) Chopping Board Mechanism

(71) Applicant: Choon Tze Meng, Singapore (SG)

(72) Inventor: Choon Tze Meng, Singapore (SG)

(21) Appl. No.: 16/357,620

(22) Filed: Mar. 19, 2019

(30) Foreign Application Priority Data
Jan. 8, 2019 (CN) 201920025069.8

(51) Int. Cl. A47J 47/00

(52) U.S. Cl. CPC A47J 47/005

(57) ABSTRACT

A chopping board mechanism includes a frame for holding a rubbish bag, and a fixture connected to the frame for attaching an edge of the rubbish bag to a chopping board. Advantageously, the frame is configured to release the rubbish bag from the frame for replacing a full rubbish bag with an empty rubbish bag.

### CROSS REFERENCE TO RELATED APPLICATIONS

This is a continuation application that claims the priority to and benefit of co-pending Chinese Patent Application No. 201920025069.8 filed Jan. 8, 2019, which is incorporated by reference herein in its entirety.

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND

### Technical Field

The present application relates to a chopping board mechanism, comprising a chopping board and a chopping board accessory.

### PRIOR ART

Chopping boards are widely used for preparing raw food materials, such as meats, vegetables, fruits and other cooking materials. A known chopping board is usually kept distant from a rubbish bin or other waste receptacles when in use. Food debris or liquid often remains on the known chopping board throughout usage, and may not be disposed to the rubbish bin in a timely manner. If the known chopping board has a planar surface without any confining structure, the food debris may be pushed off the known chopping board unknowingly, causing mess to surroundings of the known chopping board. Therefore, there is a need to overcome these drawbacks.

### BRIEF SUMMARY OF NON-LIMITING EXEMPLARY EMBODIMENT(S) OF THE PRESENT DISCLOSURE

The present application aims to provide a new and useful chopping board accessory (i.e. accessory) that is suitable for any chopping board or cutting board or alike sold in market. The chopping board accessory comprises a frame for holding a rubbish bag, a fixture for coupling a detachable frame to a chopping board and a joint part connecting the frame and the fixture together to form an accessory as a whole. The frame is adjustable in size in order to hold the mouth of the rubbish bag for transferring any food debris or liquid from the chopping board to the rubbish bag. In particular, the frame comprises of a first opening that is in direct contact with the chopping board for preventing any leakage between the chopping board and the rubbish bag during the transferring process. In addition, the accessory may comprise other components, such as a baffle, a top cover with a handle, a hook and a stopper.

It may be a further objective of the present application to provide a chopping board mechanism that comprises a chopping board and an accessory (also known as chopping board accessory). The chopping board mechanism is alternatively known as a cutting board apparatus or slicing board apparatus. The accessory comprises a frame for holding a rubbish bag and a fixture for coupling a detachable frame to the chopping board and a joint part connecting the frame and the fixture together to form an accessory as a whole. In particular, the frame of the accessory has a first opening and the chopping board has a second opening. The first opening of the frame is equal to or larger than the second opening of the chopping board in order to completely encompass the second opening of the chopping board. In addition, the chopping board may have an inner area for chopping which is surrounded by a channel or a groove. The channel or groove facilitates flowing off food debris or liquid. An outer periphery area is segregated by the channel or grove. A slit is particularly fabricated inside the chopping board under the second opening. The slit is exposed from the front side of the chopping board to allow insertion of the fixture of the accessory.

Essential features of the present application are provided by one or more independent claims, whilst advantageous features are presented by their dependent claims respectively.

According to a first aspect, the present application provides a chopping board mechanism that comprises a frame for holding a rubbish bag, and a fixture connected to the frame for attaching an edge of the rubbish bag to a chopping board. The frame is configured to release the rubbish bag from the frame for replacing a full rubbish bag with an empty rubbish bag. Since the chopping mechanism is able to fasten the rubbish bag to the edge of the chopping board, food debris on the chopping board can be easily pushed into the rubbish bag, instead of carrying the food debris to a more distant place. A full rubbish bag can be detached from the frame so that an empty rubbish bag can be fixed to the frame for further rubbish collection.

The fixture can be detachable from the chopping board for removing the chopping board mechanism from the chopping board. The chopping board thus can be washed and dried after usage, without being entangled by the chopping board mechanism.

The frame may be adjustable in configuration (e.g. size, shape, profile, fastening force, clamping force) for opening diverse types of rubbish bags. For example, when attached a large rubbish bag to the chopping board mechanism, the frame may be expanded in order to provide a wide opening for receiving food rubbish.

The frame optionally comprises an elongated periphery for attaching the rubbish bag to a straight edge of the chopping board. Since most chopping boards have elongated edges respectively, the straight edge facilitates seamless joint between the rubbish bag and the chopping board, preventing dropping off of the food debris.

An embodiment of the chopping board mechanism has a bridge (e.g. path) connected to the frame for providing an even surface between a top surface of the chopping board and the rubbish bag. Food debris is possible to be easily wiped into the rubbish bag by knife blade. For example, the bridge comprises a slope (e.g. slanted portion) for extending the top surface to a lower position at the rubbish bag. The food debris drops off from the top surface into the lower rubbish bag under gravity.

The frame can comprise a lid for covering an opening of the rubbish bag. The lid (e.g. top lid) prevents food odor from escaping the rubbish bag. Particularly, the lid is able to be flipped open in a single direction, but not otherward round. Food debris in the rubbish bag is stopped returning back to the chopping board. More advantageously, the frame further comprises a handle (e.g. lid handle) for opening and/or closing the top lid conveniently.

The chopping board mechanism sometimes has an anchor for coupling the frame. The anchor provides a simple and reliable support for holding the frame steadily. For example, the anchor comprises a groove (e.g. slit) for receiving an extension (e.g. extended part or protruding tongue) of the fixture steadily.

The chopping board mechanism may be made of one or more durable and washable materials. For example, the chopping board mechanism is made of stainless steel so that the chopping board mechanism can be sanitized, washed and/or reused.

According to a second aspect, the present application provides an accessory comprises a frame for holding a rubbish bag and a fixture for coupling a detachable frame to the chopping board and a joint part connecting the frame and the fixture together to form an accessory as a whole. The joint part is fabricated according to the materials of the frame and the fixture using any known method. For example, the frame and the fixture may be welded or soldered together if they are made of metallic materials. In this case, the strength of the welded or soldered accessory is strong enough to carry the weight of heavy food debris, such as bones or meats. For another example, when the frame and the fixture are commonly made of plastic materials for light weight and low cost, they can be glued together and used in the instance where the accessory is used to hold rubbish bag for light weight debris or liquid such as vegetables or fruits. Alternatively, additional apparatuses such as hollow tubes might be introduced as the joint part to combine the frame and the fixture. A first end of the frame and a first end of the fixture are inserted and fixed inside a first hollow tubes in opposite directions; while the second end of the frame and a second end of the fixture are also inserted and fixed inside a second hollow tube in opposite directions.

In particular, the frame of the accessory has a first opening that is in direct contact with the chopping board. for avoiding gaps between the chopping board and the rubbish bag. In most cases, an inlet of the rubbish bag is vertically lower than the edge of the chopping board such that food debris or liquid would flow automatically under the gravitational force. If there is any gap between the inlet of the rubbish bag and the chopping board, some debris or liquid may drop or dribble off onto the surroundings.

The frame of the accessory holds and keeps the mouth of the rubbish bag substantially open and has a hollow center to insert the rubbish bag inside the frame. The size of the frame may be fixed or adjustable for holding the mouth of the rubbish bag of any size commonly sold in market. The frame may have a gliding structure to freely expand or shrink in size. When a rubbish bag is put into the frame, the gliding structure may be adjusted to fit the mouth of the rubbish bag such that the mouth of the rubbish bag may be substantially open. A stopper may be used to hold the gliding structure such as a clamp firmly in position such that the mouth rubbish bag is kept open. Alternatively, the frame maybe made of expandable materials that would automatically keep the rubbish bag open and no stopper is need. When not in use, the frame may be adjusted to the smallest size and thus does not occupy much space in kitchen.

Optionally, the frame may further have one or more hooks for hanging a shopping bag or a tote bag that is used as the rubbish bag. The bag may be made of any material with two handle grips. Each of the handle grips of the shopping bag is firmly fixed on one hook such that the shopping bag is kept open and would not slip out of the frame when loaded with heavy food debris or liquid. For easy operation, the hooks are preferably located on the left side and the right side of the frame if the baffle is attached to the backside of the frame.

Optionally, the accessory may also have one or more baffles for avoiding splashing when sweeping or clearing food debris or liquid from the chopping board into the rubbish bag. One baffle may be simply a plate or slab and preferably attached to the back side of the frame that is opposite to the chopping board. Additional baffles may be also attached on the left side and/or the right side of the frame.

Optionally, the accessory may also have a top lid for covering the rubbish bag. Food debris or liquid may be stored in the rubbish bag for a period of time where smelly odors may emit therefrom. The top lid covers the rubbish bag when not in use and prevent the smelly odors from spreading into the kitchen or even the house. The top lid may be separated from the frame or installed on the frame with a hinge. In either design, the top lid can conveniently open or close the rubbish bag with a handler or a similar device such as a rod or a bar.

The fixture of the accessory is used for coupling the accessory to the chopping board by any known method according to specific situations. For light weight food debris such as vegetable, the fixture may be a rope, a yarn, a plie, a fiber or a strand tying the accessory to the chopping board. Alternatively, magnets may be adopted as the fixture where a first magnet may be installed permanently or temporarily to the frame of the accessory with one pole (either north or south) pointing outwards; and a second magnet is also installed permanently or temporarily to the chopping board with the other pole pointing outwards. When the frame approaches to the chopping board within a certain distance, the frame or the accessory is attracted by the magnetic force and coupled to the chopping board automatically. For heavy weight debris, a robust fixture with higher combining strength is needed, such as a steel clamp, a steel grip or even a lock if lock holes are provided in both of the frame and the chopping board. When necessary, the accessory can be easily detached from the chopping board such that the accessory would not be obstructive for routine food cutting on the chopping board. This removal of the detachable accessory allows another method of disposing the rubbish bag without removing the rubbish bag out of the frame of the accessory. This method has a great advantage when the rubbish bag is not easy or not possible to be separated from or taken out of the frame. In each of the coupling method mentioned above, the accessory can be easily detached from the chopping board for storage after clearing the food debris or liquid from the chopping board

In particular, the fixture comprises an extended part that can be inserted into the chopping board. The extended part may be a tongue of any shape that is permanently or temporarily connected to the frame. Preferably, the extended part is installed in front of the first opening of the accessory.

According to a second aspect, the present application to provide a chopping board mechanism that comprises a chopping board and an accessory. The chopping board has a second opening that would be in contact with the first opening of the accessory when the accessory is coupled to the chopping board. Therefore, the second opening and the first opening forms a path for food debris or liquid to flow from the chopping board to the rubbish bag attached to the accessory. In order to avoid any gap, the first opening of the frame is equal or larger than the second opening of the chopping board such that the first opening encompasses the second opening of the chopping board.

The chopping board may comprise one big inner area that is large enough for chopping a great variety of foods. The inner area is lower than the edge of the chopping board and preferably located at the center of the chopping board for easy operation. Chopped foods may be temporarily kept in the inner area before being transferred to containers. Food debris or liquid may also be retained in the inner area before being cleared into the rubbish bag. The inner area can be of any shape and preferably match the rectangular shape of the chopping board. Alternatively, the chopping board may have two or more small inner areas that are separated for preventing cross contamination. In this way, several types of food may be chopped simultaneously to enhance productivity. Each of the inner areas may have different sizes and depths to accommodate various types of food. For example, meats are usually needed in a small quantity in a meal and thus chopped in a smaller inner area; while vegetables or fruits are prepared in a large quantity and thus cut in a bigger inner area. The inner area may be chosen according to the way the food would be cooked. For example, a deeper inner area is needed when a piece of meat is chopped into mince with much liquid produced during chopping such that the liquid can be retained in the inner area; while the same piece of meat is cut into slice with little liquid produced in a shallower inner area. Special inner areas may be also designed to accommodate special eatable materials or peculiar cooking requirements.

Optionally, each of the inner areas is connected with the second opening of the chopping board such that food debris or liquid are easily transferred from the inner areas via the second opening and the first opening of the accessory into the rubbish bag without any leakage. Preferably, each of the inner areas may have a slanted portion such as a slope connected to the second opening for guiding food debris or liquid to flow into the first opening automatically. In this way, laborious work of clearing the chopping board is done with the help of gravitational force instead of human labor. Alternatively, all the inner areas may have a common slanted portion for saving space of the chopping board if the food debris or liquid from different inner areas are allowed to be mixed.

Optionally, the periphery area of the chopping board may act a flange for containing the chopped food temporarily. The periphery area is located on the edge of the chopping board and may circumvent the chopping board partially or completely. If the periphery area is large enough, chopped food can be moved from an inner area to the periphery area for temporary storage before being transferred to an external container. In this way, the inner area can be emptied from the chopped food and prepared for another chopping process and thus the productivity of the chopping board is enhanced. The height of the periphery area is so designed as not to obstruct or hinder the transferring of the chopped food into an external container. The periphery area may also be used for preventing splashing out of the chopping board onto a supporting table or surrounding kitchen floor. According to specific type of food and processing requirement, the periphery area may further consist of multiple pieces that can be installed vertically. In this way, the height of the periphery area can be adjusted accordingly. For example, if juicy fruits are chopped into jam, the height of the periphery area is elevated up for preventing fruits liquid splashing around; while if meats are cut into slice, the height of the periphery area is lower down since very little liquid is produced in the process.

Optionally, the chopping board may comprise a slit inside one side of the chopping board for receiving the extended part that is used as the fixture of the accessory. The shape and size of the slit is designed according to the extended part such that the accessory is firmly fixed to the chopping board when the extended part is inserted into the slit. After usage, the extended part can be dislodged from the slit such that the accessory is decoupled from the chopping board. The slit is fabricated by removing a portion of inside materials of a unitary chopping board by drilling or other suitable method. Alternatively, two matching chopping board units with pre-made half slits are assembled together to form a chopping board with a full slit inside. The chopping board may have more slits on other sides such that multiple accessories can be coupled to the chopping board. In this way, two or more rubbish bags are located around the chopping board for disposing rubbishes of different natures. Therefore, the convenient cutting board mechanism can classify rubbish according to local garbage classification. For example, plastic fruits packages are disposed into a first rubbish bag for collecting plastics; paper meat packages are disposed into a second rubbish bag for collecting pulp and paper; and food debris or liquid are disposed into a third rubbish bag for collecting organics.

Additional common features may be also included in the chopping board. For example, a through hole is fabricated from the top surface to the bottom surface of the chopping board. The thorough hole is used for hanging the chopping board to a wall or a rack via a hook. It is noted that all the common features of cutting board well known in the art are incorporated in the concept of the present application without tedious description here.

There has thus been outlined, rather broadly, the more important features of non-limiting exemplary embodiment(s) of the present disclosure so that the following detailed description may be better understood, and that the present contribution to the relevant art(s) may be better appreciated. There are additional features of the non-limiting exemplary embodiment(s) of the present disclosure that will be described hereinafter and which will form the subject matter of the claims appended hereto.

### BRIEF DESCRIPTION OF THE NON-LIMITING EXEMPLARY DRAWINGS

The novel features believed to be characteristic of non-limiting exemplary embodiment(s) of the present disclosure are set forth with particularity in the appended claims. The non-limiting exemplary embodiment(s) of the present disclosure itself, however, both as to its organization and method of operation, together with further objects and advantages thereof, may best be understood by reference to the following description taken in connection with the accompanying drawings in which:

FIG. 1 illustrates a top view of a first chopping board accessory (i.e. accessory) according to a first embodiment of the present application.

FIG. 2 illustrates a side view of a first chopping board accessory (i.e. accessory) according to a first embodiment of the present application.

FIG. 3 illustrates a top view of a first chopping board in accordance with the first embodiment of the present application.

FIG. 4 illustrates a front view of a first chopping board in accordance with the first embodiment of the present application.

FIG. 5 illustrates a first convenient cutting board mechanism including the first accessory and a first chopping board in accordance with the first embodiment of the present application.

FIG. 6 illustrates a top view of a second chopping board in accordance with the second embodiment of the present application.

FIG. 7 shows a cross-sectional view of the second chopping board 210 in accordance with the second embodiment of the present application.

FIG. 8 illustrates a top view of a third chopping board accessory (i.e. accessory) in accordance with the third embodiment of the present application.

FIGS. 9 illustrates a top view of a third chopping board in accordance with the third embodiment of the present application.

Those skilled in the art will appreciate that the figures are not intended to be drawn to any particular scale; nor are the figures intended to illustrate every non-limiting exemplary embodiment(s) of the present disclosure. The present disclosure is not limited to any particular non-limiting exemplary embodiment(s) depicted in the figures nor the shapes, relative sizes or proportions shown in the figures.

### DETAILED DESCRIPTION OF NON-LIMITING EXEMPLARY EMBODIMENT(S) OF THE PRESENT DISCLOSURE

The present disclosure will now be described more fully hereinafter with reference to the accompanying drawings, in which non-limiting exemplary embodiment(s) of the present disclosure is shown. The present disclosure may, however, be embodied in many different forms and should not be construed as limited to the non-limiting exemplary embodiment(s) set forth herein. Rather, such non-limiting exemplary embodiment(s) are provided so that this application will be thorough and complete, and will fully convey the true spirit and scope of the present disclosure to those skilled in the relevant art(s). Like numbers refer to like elements throughout the figures.

The illustrations of the non-limiting exemplary embodiment(s) described herein are intended to provide a general understanding of the structure of the present disclosure. The illustrations are not intended to serve as a complete description of all of the elements and features of the structures, systems and/or methods described herein. Other non-limiting exemplary embodiment(s) may be apparent to those of ordinary skill in the relevant art(s) upon reviewing the disclosure. Other non-limiting exemplary embodiment(s) may be utilized and derived from the disclosure such that structural, logical substitutions and changes may be made without departing from the true spirit and scope of the present disclosure. Additionally, the illustrations are merely representational are to be regarded as illustrative rather than restrictive.

One or more embodiment(s) of the disclosure may be referred to herein, individually and/or collectively, by the term “non-limiting exemplary embodiment(s)” merely for convenience and without intending to voluntarily limit the true spirit and scope of this application to any particular non-limiting exemplary embodiment(s) or inventive concept. Moreover, although specific embodiment(s) have been illustrated and described herein, it should be appreciated that any subsequent arrangement designed to achieve the same or similar purpose may be substituted for the specific embodiment(s) shown. This disclosure is intended to cover any and all subsequent adaptations or variations of other embodiment(s). Combinations of the above embodiment(s), and other embodiment(s) not specifically described herein, will be apparent to those of skill in the relevant art(s) upon reviewing the description.

References in the specification to “one embodiment(s)”, “an embodiment(s)”, “a preferred embodiment(s)”, “an alternative embodiment(s)” and similar phrases mean that a particular feature, structure, or characteristic described in connection with the embodiment(s) is included in at least an embodiment(s) of the non-limiting exemplary embodiment(s). The appearances of the phrase “non-limiting exemplary embodiment” in various places in the specification are not necessarily all meant to refer to the same embodiment(s).

Directional and/or relationary terms such as, but not limited to, left, right, nadir, apex, top, bottom, vertical, horizontal, back, front and lateral are relative to each other and are dependent on the specific orientation of an applicable element or article, and are used accordingly to aid in the description of the various embodiment(s) and are not necessarily intended to be construed as limiting.

If used herein, “about” means approximately or nearly and in the context of a numerical value or range set forth means ±15% of the numerical.

If used herein, “substantially” means largely if not wholly that which is specified but so close that the difference is insignificant.

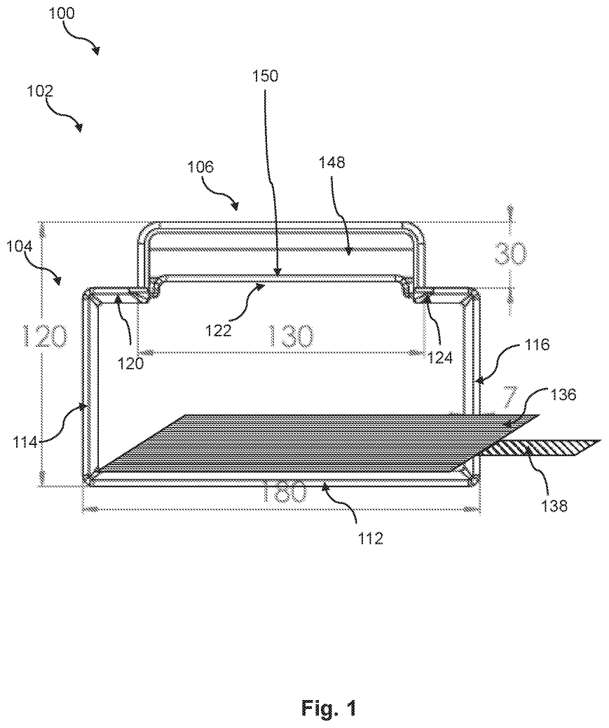

The non-limiting exemplary embodiment(s) is/are referred to generally in FIGS. 1-9 and is/are intended to provide a chopping board mechanism 100 including a frame 104 for holding a rubbish bag 108, and a fixture 106 connected to the frame 104 for attaching an edge of the rubbish bag 108 to a chopping board 110. Advantageously, the frame 104 is configured to release the rubbish bag 108 from the frame 104 for replacing a full rubbish bag 108 with an empty rubbish bag.

The reference numbers in FIG. 1-9 are listed below.

100 first embodiment;

101 first cutting board mechanism;

102 first chopping board accessory;

104 frame;

105 joint part;

106 fixture;

108 rubbish bag;

110 first chopping board;

112 back side of the first frame 104;

114 left side of the first frame 104;

116 right side of the first frame 104;

118 front side of the first frame 104;

120 front left side of the first frame 104;

122 first opening;

124 front right side of the first frame 104;

126 first baffle (back side 112);

128 second baffle (left side 114);

130 third baffle (right side 116);

132 fourth baffle (front left side 120)

134 fifth baffle (front right side 124);

136 top lid;

138 lid handler;

140 left hook;

142 right hook;

144 left handle grip;

146 right handle grip;

148 extended part;

150 hinge;

156 front side of the first chopping board 110;

158 left side of the first chopping board 110;

160 right side of the first chopping board 110;

162 back side of the first chopping board 110;

164 front left side of the first chopping board 110;

166 second opening;

168 front right side of the first chopping board 110;

170 flowing path;

172 food debris or liquid;

174 inner area;

176 periphery area;

178 channel;

180 slanted portion;

182 through hole;

184 back right corner of the first chopping board 110;

186 slit;

200 second embodiment;

201 second cutting board mechanism;

202 second chopping board accessory;

204 frame;

205 joint part;

206 fixture;

207 first opening;

208 rubbish bag;

210 second chopping board;

212 extended part;

214 front side of the second chopping board 210;

216 back side of the second chopping board 210;

218 left side of the second chopping board 210;

220 right side of the second chopping board 210;

222 front left side of the second chopping board 210;

224 second opening;

226 front right side of the second chopping board 210;

228 flowing path;

230 food debris or liquid;

232 inner area;

234 periphery area;

236 channel;

238 slanted portion;

240 through hole;

224 back portion of the channel 236

226 first depth;

228 left portion of the channel 236;

230 second depth;

232 right portion of the channel 236;

234 third depth;

236 front left portion of the channel 236;

238 fourth depth;

240 front right portion of the channel 236;

242 fifth depth;

244 back right corner of the chopping board 210;

246 slit;

248 top surface of the slit 246;

250 lowest point of the slanted portion 238;

300 third embodiment;

301 third cutting board mechanism;

302 third chopping board accessory;

304 third chopping board;

305 frame;

306 fixture;

308 fixing device;

310 first rope;

312 front left corner of the frame 315;

314 second rope;

316 front right corner of the frame 315;

318 fixing apparatus;

320 first crook;

322 front left corner of the third chopping board 304;

324 second crook;

326 front right corner of the third chopping board 304;

FIG. 1 to FIG. 5 show a first embodiment 100 of the present application. FIG. 1 illustrates a top view of a first chopping board accessory (i.e. accessory) 102. The first accessory 102 comprises a frame 104, a joint part 105 (not shown) and a fixture 106. The first accessory 102 is a single unitary apparatus in the first embodiment 100 in that the frame 104 and the fixture 106 are physically combined via the joint part 105 to form the first accessory 102 as a whole. The frame 104 and the fixture 106 are used for holding a rubbish bag 108 open and coupling the first accessory 102 to a first chopping board 110, respectively.

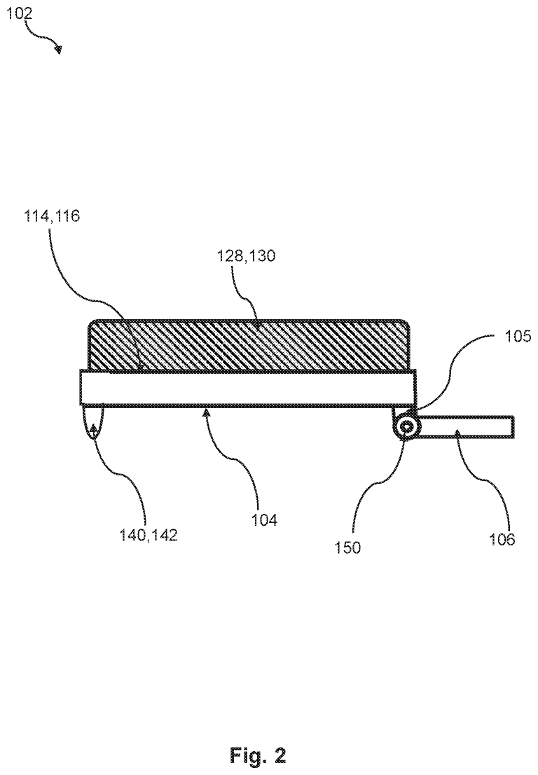

As shown in FIG. 1, the frame 104 has a rectangular shape including a back side 112, a left side 114, a right side 116 and a front side 118. The back side 112 and the front side 118 has a same length of 180 mm; while the left side 114 and the right side 116 has a same width of 90 mm. The front side 118 further has a short front left side 120, the first opening 122 and a short front right side 124. The first opening 122 has a length of 130 mm. All of the five sides (112, 114, 116, 118 and 120) of the frame 104 have a same thickness of 7 mm. FIG. 2 shows a side view of the first accessory 102, indicating that the first accessory 102 has a total height of 17.5 mm which includes a height of 8.6 mm for the frame 104, a height of 3.9 mm for the joint part and a height of 5 mm for the fixture 106.

The frame 104 comprises a first baffle 126 attached on the back side 112 for preventing splashing from the first chopping board 110 to the area behind the back side 112. To protect the surrounding environment better, the frame 104 may further selectively have either or all of a second baffle 128 attached on the left side 114, a third baffle 130 attached on the right side 116, a fourth baffle 132 attached on the short front left side 120, and a fifth baffle 134 attached on the short front right side 124.

The frame 104 comprises a top lid 136 for covering the rubbish bag 108. The size of the top lid 136 is preferably equal to or larger than the frame 104 for completely covering the rubbish bag 108 such that smelly odors from the rubbish bag 108 would not be leaked out into the kitchen. The top lid 136 may have a lid handler 138 for opening and closing the top lid 136 easily.

The frame 104 comprises a left hook 140 beneath the left side 114 and a right hook 142 beneath the right side 116 for holding the rubbish bag 108 more firmly in the frame 104. Accordingly, the rubbish bag 108 is preferred to have a left handle grip 144 and a right handle grip 146. When the rubbish bag 108 is put into the frame 104, the left handle grip 144 and the right handle grip 146 are fixed into the left hook 140 and the right hook 142, respectively.

The fixture 106 of the first accessory 102 comprises a extended part 148 permanently or temporarily connected to the frame 104 at the location of the first opening 122. As shown in FIG. 1, the extended part has a same length of the first opening 122 of 130 mm and a width of 30 mm.

FIG. 2 illustrates a side view of a first chopping board accessory (i.e. accessory) according to a first embodiment of the present application. The extended part 148 is vertically connected to the frame 104 and thus the extended part 148 is located below the frame 104 with a height of 5 mm. The extended part 148 may further have a hinge 150 that can rotate the frame 104 upwards or downwards the fixture 106. In this way, the first accessory 102 provides more freedom for handling the rubbish bag 108.

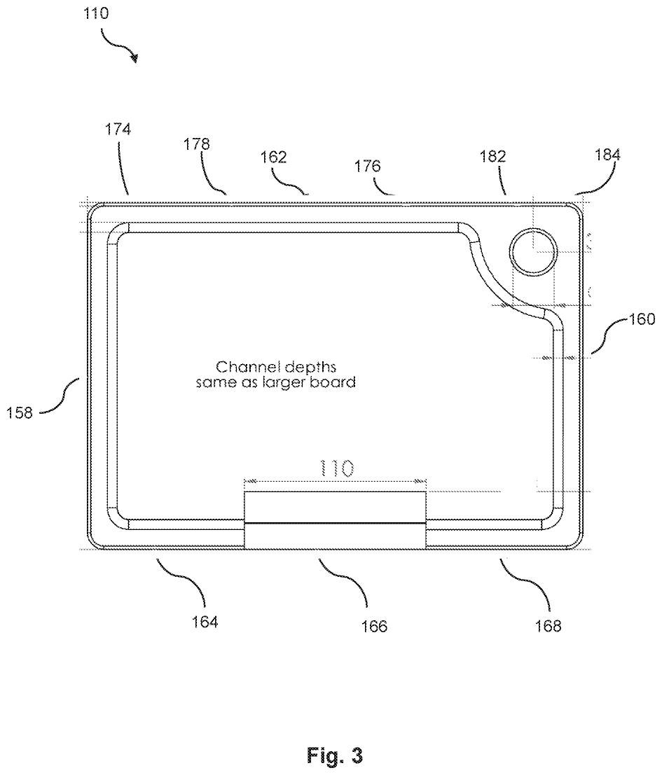

FIG. 3 illustrates a top view of a first chopping board 110 in accordance with the first embodiment 100 of the present application. The first chopping board 110 has a rectangular shape, including a front side 156, a left side 158, a right side 160 and a back side 162. The front side 156 and the back side 162 have a same length of 300 mm; while the left side 158 and the right side 160 have a same length of 210 mm. The front side 156 of the first chopping board 110 further has a short front left side 164, a second opening 166 and a short front right side 168. The second opening 166 has a length of 110 mm. When the first accessory 102 is coupled to the first chopping board 110, the first opening 122 is in direct contact with the first chopping board 110 at the second opening 166 for forming a flowing path 170 for food debris or liquid 172 to flow along from the first chopping board 110 into the rubbish bag 108. The length of the first opening 122 is larger than that of the second opening 166 such that the first opening 122 can encompass the second opening 166 entirely for preventing any leakage along the flowing path 170.

The first chopping board 110 comprises an inner area 174 for chopping eatable materials, a periphery area 176 and a channel 178 for separating the inner area 174 and the periphery area 176. The inner area 174 has a polygonal shape that is connected to the second opening 166. The channel 178 has a width of 6 mm and a same depth along the first channel 178. The first chopping board 110 also has a distance of 10 mm between the outer side of the channel 178 and the back side 162 of the first chopping board 110. The channel 178 is connected to the second opening 166.

The inner area 174 further comprises a slanted portion 180 connected to the second opening 166. The slanted portion 180 is used for guiding food debris or liquid 172 through the second opening 166 and the first opening 122 into the rubbish bag 108. The slanted portion 180 has a same length of the second opening 166 of 110 mm and a width of 35 mm to the second opening 166.

The first chopping board 110 comprises a through hole 182 at the back right corner 184 in the periphery area 176. The through hole 182 has a diameter of 25 mm. The center of the first through hole 182 has a same distance of 30 mm to the back side 162 and the right side 160. The through hole 182 is used to hang the first chopping board 110 onto a wall or other places.

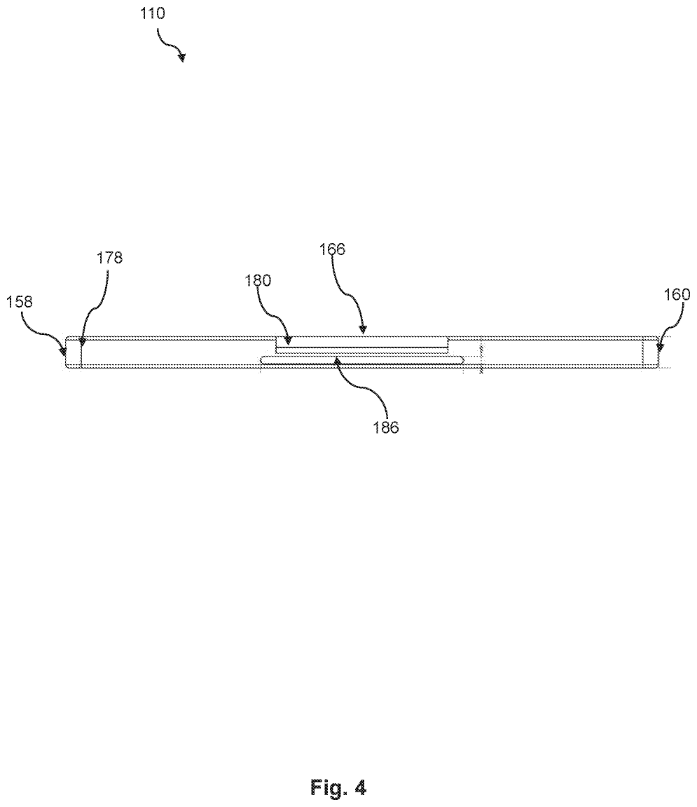

FIG. 4 shows a front view of the first chopping board 110. The chopping board 110 has a thickness of 20 mm. The first chopping board 110 comprises a slit 186 inside thereof. As shown in FIG. 4, the slit 186 is located at and exposed from the front side 156 of the first chopping board 110. The slit 186 is also located under the second opening 166 and the slanted portion 180. The slit 186 has a length of 130 mm and a height of 5 mm, both of which are exactly equal to the dimensions of the extended part 148 of the first accessory 102 for tightly accommodating the extended part 148 inside the first chopping board 110.

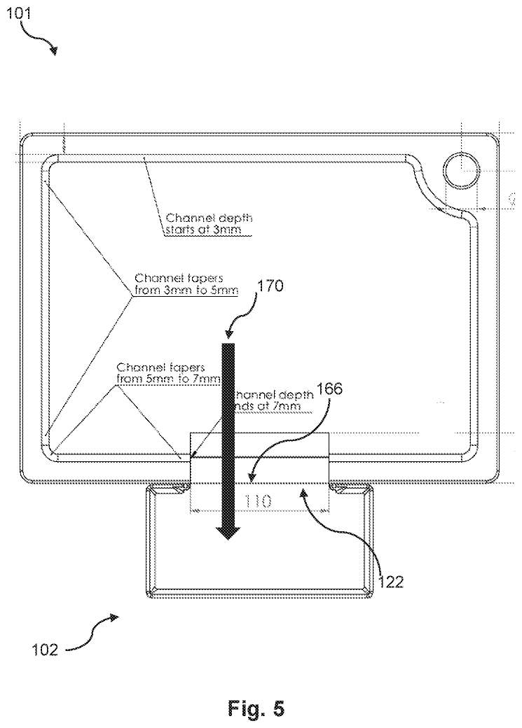

FIG. 5 illustrates a first convenient cutting board mechanism 100 where the first accessory 102 inserted into the first chopping board 110 in accordance with the first embodiment of the present application. The extended part 148 (not shown) is inserted into the slit 186 such that the first accessory 102 with the rubbish bag 108 is coupled to the first chopping board 110 to form the first cutting board mechanism 101. The first opening 122 is in direct contact with the first chopping board 110 at the location of the second opening 166 for forming a flowing path 170 for food debris or liquid 172 to flow along from the first chopping board 110 into the rubbish bag 108.

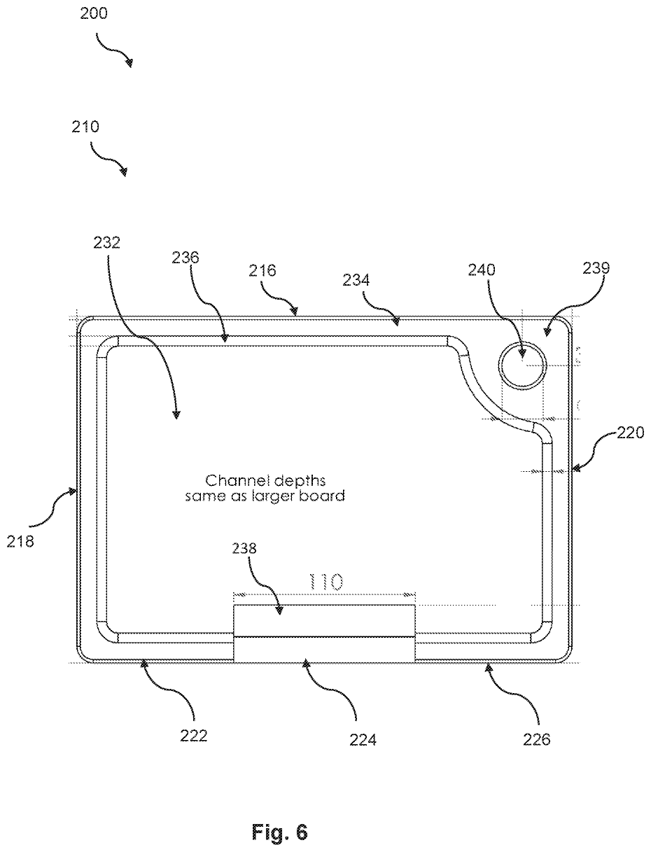

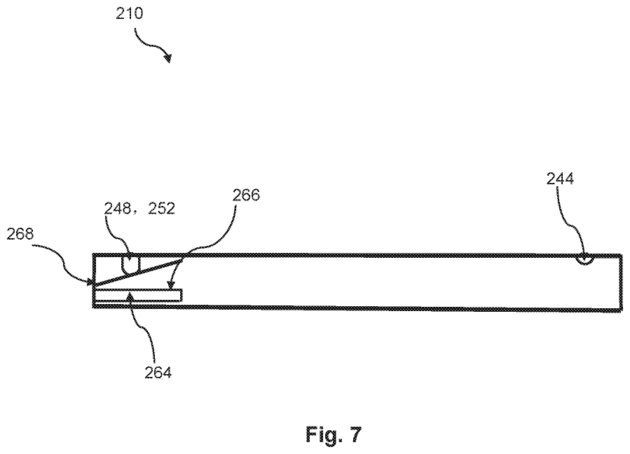

FIG. 6 and FIG. 7 show a second embodiment 200 of the present application. A second cutting board mechanism 201 comprises a second chopping board accessory (i.e. accessory) 202 and a second chopping board 210. Similar to the first accessory 102, the second accessory 202 has a frame 204, a joint part 205 and a fixture 206. The frame 204 has a first opening 207 and is also used for holding a rubbish bag 208; the joint part 205 is also adopted for connecting the frame 204 and the fixture 206. The fixture 206 comprises an extended part 212 for coupling the second accessory 202 to the second chopping board 210. Each component of the second accessory 202 has the same dimension of the counterpart of the first accessory 102 in the first embodiment 100.

FIG. 6 shows a top view of the second chopping board 210 that is similar to the first chopping board 110. However, the second chopping board 210 is larger in some dimensions. For example, a front side 214 and a back side 216 have a same length of 380 mm; while a left side 218 and a right side 220 have a same length of 278 mm. The front side 214 of the second chopping board 210 further has a short front left side 222, a second opening 224 and a short front right side 226. The second opening 224 has a length of 110 mm. When the second accessory 202 is coupled to the second chopping board 210, the first opening 207 is in direct contact with the second chopping board 210 at the location of the second opening 224 for forming a flowing path 228 for food debris or liquid 230 to flow along from the second chopping board 210 into the rubbish bag 208. The length of the first opening 207 is larger than that of the second opening 224 such that the first opening 207 can encompass the second opening 224 entirely for preventing any leakage along the flowing path 228.

The second chopping board 210 also comprises an inner area 232 for chopping eatable materials, a periphery area 234 and a channel 236 for separating the inner area 232 and the periphery area 234. The inner area 232 has a polygonal shape that is connected to the second opening 224. Similar to the channel 178 of the first embodiment 100, the channel 236 is also connected to the second opening 224. The channel 236 still has a width of 6 mm, but the depth of the channel 236 depends on the specific location on the second chopping board 210. For example, the back portion 224 has a unitary first depth 226 of 3 mm along the back side 216; while the left portion 228 and the right portion 232 have gradient second depth 228 and third depth 234, respectively. Both of the second depth 228 and the third depth 234 range from 3 mm at the back side 216 to 5 mm at the front side 214. The front left potion 236 and the front right potion 240 also have gradient fourth depth 238 and fifth depth 242, respectively. The fourth depth 238 varies from 5 mm at the left side 218 to 7 mm at the second opening 224 along the front left side 222; and the fifth depth 242 changes from 5 mm at the right side 220 to 7 mm at the second opening 224 along the front right side 226. The second chopping board 210 has a distance of 15 mm between the outer side of the channel 236 and each side of the second chopping board 210.

The inner area 232 further comprises a slanted portion 238 connected to the second opening 224. The slanted portion 238 is used for guiding food debris or liquid 230 through the second opening 224 and the first opening 207 into the rubbish bag 208. The slanted portion 238 has a same length of the second opening 224 of 110 mm and a width of 40 mm to the second opening 224.

The second chopping board 210 comprises a through hole 240 at the back right corner 244 in the periphery area 234. The through hole 240 has a diameter of 25 mm. The center of the through hole 240 has a same distance of 30 mm to the back side 216 and the right side 220. The through hole 240 is used to hang the second chopping board 210 onto a wall or other places.

FIG. 7 shows a cross-sectional view of the second chopping board 210. The second chopping board 210 still has a thickness of 20 mm. The second chopping board 210 comprises a slit 246 inside thereof. As shown in FIG. 7, the slit 246 is located at and exposed from the front side 214 of the second chopping board 210. The slit 246 is also located under the second opening 224 and the slanted portion 238. The top surface 248 of the slit 246 has a distance of 2 mm under the lowest point 250 of the slanted portion 238. The slit 246 has a length of 130 mm and a height of 5 mm, both of which are exactly equal to the dimensions of the extended part 212 for tightly accommodating the extended part 212 inside the second chopping board 210.

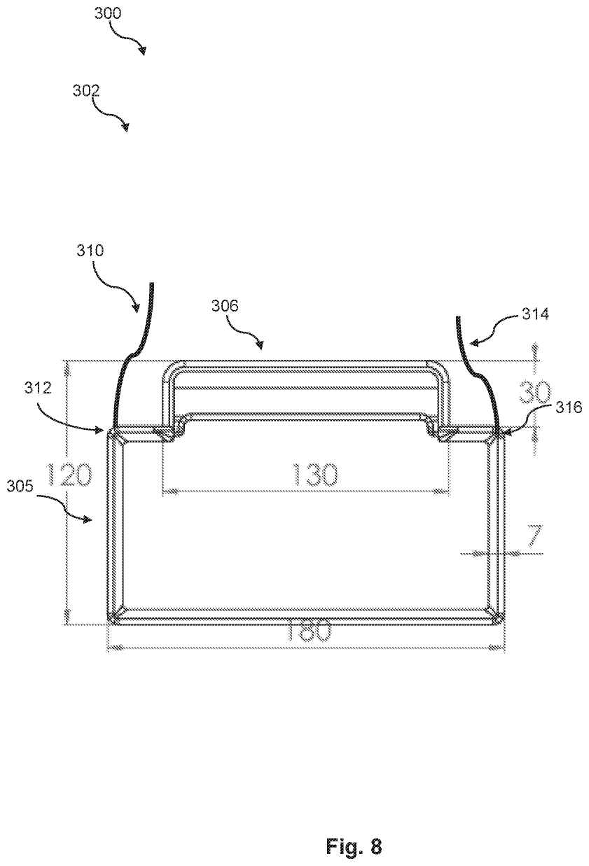

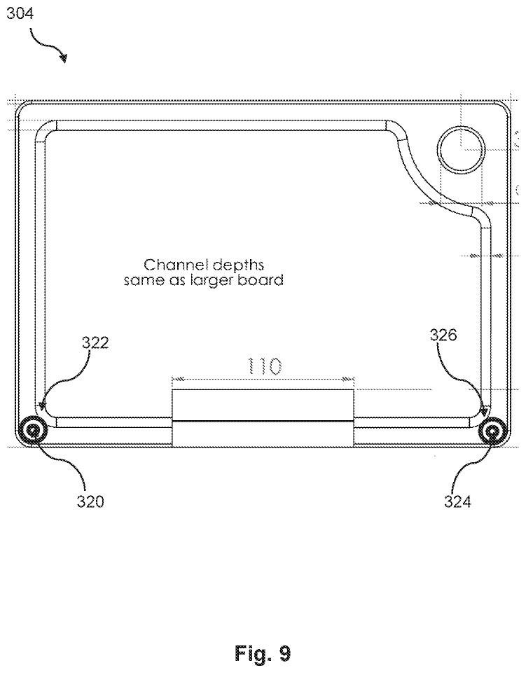

FIG. 8 and FIG. 9 show a third embodiment 300 of the present application. A third cutting board mechanism 301 comprises a third chopping board accessory (i.e. accessory) 302 and a third chopping board 310. The third accessory 302 is similar to either the first accessory 102 or the second accessory 202; while the third chopping board 304 is similar to either the first chopping board 110 or the second chopping board 210 accordingly. The third accessory 302 is detachably coupled to the third chopping board 304 with a fixture 306 that is identical or similar to either the fixture 106 of the first embodiment 100 or the fixture 206 of the second embodiment 200. The third accessory 302 also has a frame 305 that is similar to either the frame 104 of the first embodiment 100 or the frame 204 of the second embodiment 200.

Different from the first accessory 102 and the second accessory 202, the third accessory 302 additionally comprises one or more fixing devices 308 such as ropes or clamps for providing additional force to prevent decoupling of the third accessory 302 and the third chopping board 304 during usage. As shown in FIG. 8, a first rope 310 is attached at the front left corner 312 of the frame 305; and a second rope 314 is also attached at the front right corner 316 of the frame 305.

FIG. 9 illustrates a top view of a third chopping board. Different from the first chopping board 110 and the second chopping board 210, the third chopping board 304 additionally comprises one or more fixing apparatuses 318 such as crooks or clasps for binding with the fixing devices 308 to prevent decoupling of the third accessory 302 and the third chopping board 304 during usage. As shown in FIG. 8, a first crook 320 is attached at the front left corner 322 of the third chopping board 304; and a second crook 324 is also attached at the front right corner 326 of the third chopping board 304.

Before using the third convenient cutting board mechanism, the third accessory 302 is coupled to the third chopping board 304. Additional coupling force is provided in the third embodiment 300 by tying the first rope 310 and the second rope 314 to the first crook 320 and the second crook 324, respectively.

As an alternative design of the third convenient cutting board mechanism 301, the fixing devices 308 including the first rope 310 and the second rope 314 can be attached on the third chopping board 304; while the fixing apparatuses 318 including the first crook 320 and the second crook 324 can be attached on the third accessory 302.

In the application, unless specified otherwise, the terms “comprising”, “comprise”, and grammatical variants thereof, intended to represent “open” or “inclusive” language such that they include recited elements but also permit inclusion of additional, non-explicitly recited elements.

As used herein, the term “about”, in the context of concentrations of components of the formulations, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. The description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

While non-limiting exemplary embodiment(s) has/have been described with respect to certain specific embodiment(s), it will be appreciated that many modifications and changes may be made by those of ordinary skill in the relevant art(s) without departing from the true spirit and scope of the present disclosure. It is intended, therefore, by the appended claims to cover all such modifications and changes that fall within the true spirit and scope of the present disclosure. In particular, with respect to the above description, it is to be realized that the optimum dimensional relationships for the parts of the non-limiting exemplary embodiment(s) may include variations in size, materials, shape, form, function and manner of operation.

The Abstract of the Disclosure is provided to comply with 37 C.F.R. § 1.72(b) and is submitted with the understanding that it will not be used to interpret or limit the scope or meaning of the claims. In addition, in the above Detailed Description, various features may have been grouped together or described in a single embodiment for the purpose of streamlining the disclosure. This disclosure is not to be interpreted as reflecting an intention that the claimed embodiment(s) require more features than are expressly recited in each claim. Rather, as the following claims reflect, inventive subject matter may be directed to less than all of the features of any of the disclosed non-limiting exemplary embodiment(s). Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiment(s) which fall within the true spirit and scope of the present disclosure. Thus, to the maximum extent allowed by law, the scope of the present disclosure is to be determined by the broadest permissible interpretation of the following claims and their equivalents, and shall not be restricted or limited by the above detailed description.

What is claimed as new and what is desired to secure by Letters Patent of the United States is:

1. A chopping board mechanism comprising:
a frame for holding a rubbish bag, and
a fixture connected to the frame for attaching an edge of the rubbish bag to a chopping board;
wherein the frame is configured to release the rubbish bag from the frame for replacing a full rubbish bag with an empty rubbish bag.

2. The chopping board mechanism of claim 1, wherein the fixture is detachable from the chopping board for removing the chopping board mechanism from the chopping board.

3. The chopping board mechanism of claim 1, wherein the frame is adjustable in configuration for opening diverse types of rubbish bags.

4. The chopping board mechanism of claim 1, wherein the frame comprises: an elongated periphery for attaching the rubbish bag to a straight edge of the chopping board.

5. The chopping board mechanism of claim 1, further comprising: a bridge connected to the frame for providing a smooth surface between a top surface of the chopping board and the rubbish bag.

6. The chopping board mechanism of claim 5, wherein the bridge comprises: a slope for extending the top surface to a lower position at the rubbish bag.

7. The chopping board mechanism of claim 1, wherein the frame comprises: a lid for covering an opening of the rubbish bag.

8. The chopping board mechanism of claim 1, further comprising: a chopping board having an anchor for coupling the frame.

9. The chopping board mechanism of claim 8, wherein the anchor comprises: a groove for receiving the fixture steadily.

10. The chopping board mechanism of claim 1, wherein the chopping board mechanism is made of at least one durable and washable material.
